(19) United States
(12) Patent Application Publication
(10) Pub. No.: US 2002/0119371 A1
(43) Pub. Date: Aug. 29, 2002

(54) Method of fabricating electrode foils and galvanic elements fabricated from the method

(76) Inventors: Peter Haug, Ellwangen (DE); Peter Birke, Ellwangen (DE); Konrad Holl, Aalen-Dewangen (DE); Dejan Ilic, Ellwangen (DE)

Correspondence Address: Schnader Harrison Segal & Lewis LLP, Suite 3600, 1600 Market Street, Philadelphia, PA, 19103, US

(21) Appl. No.: 10/061,643

(22) Filed: Feb. 1, 2002

(30) Foreign Application Priority Data
Feb. 3, 2001 (DE) DE 101 04 988.9

(51) Int. Cl. H01M 4/62; H01M 4/66; H01M 4/50; H01M 4/48; H01M 4/52

(52) U.S. Cl. 429/217; 429/245; 29/2; 429/232; 429/231.95; 429/231.1; 429/231.2; 429/231.3; 429/221; 429/224; 429/223; 141/1.1

(57) ABSTRACT

A wet-chemical method of fabricating electrode foils for galvanic elements including dissolving at least two different fluorinated polymers in a solvent, mixing a highly conductive carbon black, whose BET surface area is between that of surface-minimized graphite and activated carbon and an electrochemically active material having a two-dimensional layer structure and an electronic conductivity of at least about 10⁻⁴ S/cm into which lithium can be reversibly incorporated and be reversibly removed therefrom with the least two polymers dissolved in the solvent, without additions of plasticizers, swelling agents or electrolyte, applying paste composition thus obtained to an electrode collector or a support foil, and drying the paste composition.

### FIELD OF THE INVENTION

This invention relates to a wet-chemical method of fabricating electrode foils for galvanic elements which include at least one lithium-intercalating electrode and a galvanic element comprising electrodes fabricated via the method.

### BACKGROUND

For reasons of electrochemical stability, especially with respect to the positive electrode, only a limited number of materials can be used as binders of the electrochemically active pastes in lithium-based galvanic elements. Apart from polyolefins these, in particular, include fluorinated polymers.

U.S. Pat. No. 4,828,834 A1 describes the use of polytetrafluroethylene (PTFE) in a rechargeable cell comprising lithium-intercalating electrodes. This involves the addition of only a few percent by weight, values given by way of example being 1.8 and 5%, of PTFE as a binder, the electrodes being obtained by cold-pressing at typical values of 3 t/cm².

U.S. Pat. No. 5,631,104 A1 discloses, as a binder for the electrochemically active pastes, an ethylene-propylene-diene monomer which, for processing purposes, is dissolved in cyclohexane. The paste thus obtained is applied to a support foil and dried.

WO 98/20566 A1 describes a method in which a polyvinylidene homopolymer is mixed in the dry state with a filler such as SiO₂ or Al₂O₃. Then, a plasticizer, e.g., dimethyl adipate, is added and the mixture preformed to produce an electrode blank or separator blank that is processed in a hot-pressing or melting method above the softening point, but below the melting point of the polymer.

U.S. 5,296,318 A1 describes the fabrication of intrinsically conductive separators, starting from a poly(vinylidene fluoride)-hexafluoropropylene (PVDF-HFP) co-polymer which can be laminated to electrode foils. Due to the incorporated electrolyte salts, however, the separator foils are strongly hygroscopic and, depending on the electrolyte salt, may also be hydrolysis-sensitive with the release of hydrofluoric acid.

Drawbacks with respect to the practical implementation of such methods include the high costs for dry chambers and protective gas atmospheres required for the process as a whole.

U.S. Pat. No. 5,460,904 A1 specifies a method of fabricating activateable, rechargeable lithium ion batteries, in which electrochemically active materials, additives such as, optionally, conductivity improvers in the electordes or stabilizers in the separator, a special polymer-copolymer poly(vinylidene fluoride)-hexafluoropropylene (PVDF-HFP) and significant proportions of a plasticizer, typically dibutyl pthalate (DBP), after acetone has been added to dissolve the polymer, are intensively mixed and drawn out to produce a foil. These foils are processed in a plurality of lamination processes to produce so-called “bicells,” a plurality of bicells forming a stack which, having been inserted into coated deep-drawn aluminum foil, filled with electrolyte, sealed, formed, degassed and finally sealed, constitutes the finished cell. In the process, the above-mentioned plasticizer must first be completely removed from the bicells in a laborious extraction step, as it is electrochemically unstable in a charged cell and might cause irreversible damage to the cell during the first charging operation. This extraction step is time- and cost-intensive, and the recovered plasticizer is too heavily contaminated, as a general rule, to be reused and, consequently, causes considerable cost. The solvents proposed for extraction are, as a general rule, the highly toxic and explosive methanol or the no less flammable hexane.

DE 196 52 174 A1 proposes the use of plasticizers which are electrochemically stable and, therefore, need not be washed out. Pore formation for subsequent uptake of the electrolyte can be achieved thermally, i.e., significant proportions of the plasticizer can be extracted thermally and under vacuum. A major advantage is that extraction of the plasticizer need no longer be taken to completion. This does not, however, do away with the laborious extraction step and the necessary recycling. Costs further arise from the plasticizer itself, and the plasticizer extracted in ovens has to be collected and disposed of. This may lead to considerable contamination within and around the ovens, especially within and around the cooling zones, where quite considerable quantities of plasticizer may be deposited. Due to saturation effects in the oven chamber, caused by the saturation pressure of the generally high-boiling plasticizer, the extraction may even come to a complete stop, thereby requiring laborious drying by the treatment chamber being repeatedly flooded and reevacuated, which is a time-consuming process.

It would accordingly be highly advantageous to simplify the known methods of fabricating polymer electrodes.

### SUMMARY OF THE INVENTION

This invention relates to a wet-chemical method of fabricating electrode foils for galvanic elements including dissolving a co-polymer consisting of at least two different fluorinated polymers in a solvent, mixing a highly conductive carbon black, whose BET surface area is between that of surface-minimized graphite and activated carbon and an electrochemically active material having a two-dimensional layer structure and an electronic conductivity of at least about 10⁻⁴ S/cm into which lithium can be reversibly incorporated and be reversibly removed therefrom with a co-polymer consisting of least two polymers dissolved in the solvent, without additions of plasticizers, swelling agents or electrolyte, applying a paste composition thus obtained to an electrode collector or a support foil, and drying the paste composition.

This invention also relates to a galvanic element comprising at least one electrode foil which is fabricated via the method above.

This invention further relates to the galvanic element wherein a positive electrode foil and a negative electrode foil fabricated via the above method are laminated onto a separator and a thus obtained stack is impregnated with a liquid organic electrolyte.

### BRIEF DESCRIPTION OF THE DRAWINGS

FIG. 1 is a graph showing the trend of discharge voltage and electrode current in a cell according to the invention under a C/5 load.

FIGS. 2 and 3 are graphs showing the change of the capacity K as a function of the number of cycles n at temperatures of 20° C. (FIG. 2) and 60° C. (FIG. 3) and currents of C/2.

### DETAILED DESCRIPTION

The method according to the invention allows an electrode on the basis of fluorine-containing polymers, co-polymers of vinylidene fluoride and hexafluoropropylene with their high electrochemical stability being preferred, to be fabricated as a self-supporting foil in a wet-chemical process or to be applied to a substrate such as a polyester foil or directly onto a collector electrode and then to be hot-laminated in a continuous process, which is indispensable for high productivity, to form a layer composite structure, thereby achieving the advantage of a compact-optimized composite cell structure which no longer depends on the intrinsic application of pressure as in round cells by means of special coiling techniques or by external pressure resulting from a rigid and, consequently, generally heavy metal casing. The foils are fabricated under normal ambient conditions and not until the cell is being encased is electrolyte finally metered in under a protective gas atmosphere.

As shown by the prior art mentioned at the outset, it has hitherto been the general view that a plasticizer is required to prevent sedimentation of the solid constituents. This is because the foils are drawn and need to maintain sufficient flexibility in the subsequent fabrication process which involves many guide rollers and repeated coiling and uncoiling. Furthermore, the plasticizer had the purpose of occupying space to provide adequate microporosity for the subsequent charging with electrolyte, so that significant portions had to be extracted again. Moreover, the plasticizer in the electrodes is intended to allow them to adhere to the collector or separator through the lamination process.

According to the invention it has been found, however, that it is possible to dispense entirely with the addition of plasticizer in fabricating sufficiently flexible foils without sedimentation effects, and that evaporation of acetone, which is preferred as a solvent besides 1-methyl-2-pyrrolidine, during the fabrication process is sufficient, along with natural embrittling or aging of the polymer, to provide adequate microporosity for subsequent charging with electrolyte. The uptake of electrolyte is additionally promoted by the conductivity improvers, preferably carbon modifications with high absorbence, which are present in the electrodes, so that the plasticizer does not, as with the known methods, present the only way in which the porosity can be provided. An important advantage of the method according to the invention is that the plasticizer and its removal with all the above-mentioned drawbacks is entirely dispensed with, and the melting point of the polymer can be utilized to bond the electrodes to the collector electrodes and the separator. If lithium salts and/or plasticizer are already present during this step, this will result, as a general rule, in lower melting points and possible release of gas due to electrolyte salt decomposition and, as a general rule, evaporating plasticizer. The latter may be deposited during lamination as a liquid film on the electrode surfaces and impede bonding.

According to the invention, the method, which can be implemented wet-chemically without a plasticizer, provides a porous structure which is subsequently charged with a liquid electrolyte. The system thus remains a liquid-electrolyte cell.

The complete replacement of the plasticizer utilizes inorganic substances or compounds as a substituent which in addition to the desired electrochemical properties also contribute special structural and mechanical properties. In lithium intercalation cells, very special types of carbon black are used to improve the electronic conductivity of the electrodes, which carbon black combines a number of characteristics to achieve an excellent result. In addition to high electronic conductivity, comparable to that of graphite in the preferential direction, the effective surface area, i.e., the BET surface area, should at the same time be kept as low as possible. This is advantageous to minimize the surface area of reaction with the liquid organic electrolyte, as the reaction layer irreversibly consumes lithium during its formation and increases the cell resistance as a function of its thickness. Using surface area-minimized graphites, comparatively lower surface area values can be achieved.

Graphites themselves, however, are unsuitable for improving the conductivity in the negative electrode, despite their low BET surface area, as they intercalate lithium and in the process on their surface form a passivation layer, SEI, “solid electrolyte interface”, which only conducts ions, as a reaction product with the liquid organic electrolyte. Nor are graphites capable of storing a certain amount of liquid electrolyte.

In sharp contrast, a carbon black suitable according to the invention additionally has this advantageous storage property and is able to increase the amount of electrolyte in the electrodes and thereby the ion conductivity of the electrodes. The lattice structure of such a carbon black is such that virtually no intercalation of lithium is possible and, consequently, no SEI comparable with the situation in the case of graphite is formed. The mechanical properties of foils are advantageously improved by such types of carbon black, thus making them highly suitable as a replacement for plasticizers.

Suitable types of carbon black according to the invention have a BET surface area of about 50-about 500 m²/g, preferably about 50-about 150 m²/g and especially about 50-about 80 m²/g, and a minimum conductivity of about 10³ S/cm. The bulk density should be in the range of about 0.05-about 0.30 g/cm³, and the liquid uptake should be about 1-about 20 ml/g, preferably about 5-about 10 ml/g. The carbon black can be used equally in the positive and the negative electrode in an amount of from about 0.1 to about 20% by weight, preferably of about 2 to about 6% and especially of about 2-about 2.5% by weight (negative side) and of about 4.5-about 5.5% by weight (positive side). The quantities given refer to the paste batch as a whole, including solvent. (Such types of carbon black are marketed under the trade name Super P by Sedema or Keitjen Black, for example.)

Generally, materials having a layer structure such as graphite or LiCoO₂ are mechanically eminently suitable for substituting for the plasticizer. This can be illustrated by the lubricating effect of graphite. For the reasons mentioned, graphite will only be used in the positive electrode. A clear distinction should be drawn in this context between graphites to improve conductivity in the positive electrode and graphites for use as active lithium-intercalating material in the negative electrode. Graphites to be used as conductivity improvers are typically very fine, with grain sizes down to a few micrometers, and their property of reversibly intercalating lithium is adverse in the sense of too high an irreversible uptake of lithium, especially during the first half-cycle, whereas graphites for use as active material in the negative electrode must have grain sizes of at least 20 micrometers, advantageously in the range of 20-40 micrometers, and their suitability as an active material is additionally based on their special structure and surface area.

LiCoO₂ represents an example of Li—Me—O compounds. Me here means transition metals. The oxygen can be replaced by fluorine to increase the electrochemical stability. Structure-stabilizing main-group elements such as Mg or Al can also be advantageous. These can have a beneficial effect on the electrochemical high-temperature stability within the cell. On electrochemical grounds, i.e., their potential relative to lithium, these compounds are employed only in the positive electrode. Generally, suitable as the electrochemically active material for a positive electrode foil are materials selected from the group consisting of ternary (Li—Me1-O) or quaternary (Li—Me1-Me2-O) lithium transition metal oxides, where Me1 and Me2 are selected from the group consisting of Ti, V, Cr, Fe, Mn, Ni, Co, and the compound optionally additionally contains up to about 15 atom percent of Mg, Al, N or F to stabilize the structure.

The electrochemically active material used for the negative electrode foil is a graphitized carbon modification.

Products of reaction with the liquid organic electrolyte in the charged cell, such as Li₂CO₃ or LiOH, are also assumed on the positive side, which is why the active lithium-intercalating material as a replacement for the plasticizer in the positive electrode will, according to the invention, have a BET surface area of about 0.1-about 2 m²/g, a basic pH of about 9-about 11.5 and a grain size of about 1-about 50 micrometers. If required, a surface treatment with Li₂CO₃ of LiOH is carried out. Typical for these materials is a powder density of about 1.9-about 2.6 g/cm³ and a density of about 3.8-about 4.3 g/cm³. Preferred quantities are about 0.1-about 25% by weight, preferably about 5-about 20% and, particularly, preferably about 10-about 15% by weight. The amounts given relate to the paste batch overall, including solvent. LiCoO₂ has very good electrochemical properties with a ratio Li/Co of from about 0.98 to about 1.05 and a preparation temperature of at least about 650° C.

The solvent content in the paste for fabricating the foils should be about 50-about 75 percent by weight, preferably about 55-about 75 percent by weight and particularly preferably about 57.5-about 62.5 percent by weight.

The PVDF/HFP ratio in the positive electrode foils is between at most about 99.5 and at least about 0.5, preferably between at most about 80 and at least about 20, and the ratio of the molecular weight between PVDF/HFP is between about 3.2 and about 2.8, preferably between about 2.3 and about 2.5. The PVDF/HFP ratio for negative electrode foils is between at most about 99.5 and at least about 0.5, preferably between at most about 85 and at least about 15, and the ratio of the molecular weights between PVDF/HFP is between about 3.2 and about 2.8, preferably between about 2.3 and about 2.5. The densities are between about 1.6 and about 1.9 g/cm³, preferably between about 1.7 and about 1.8 g/cm³ and, particularly, preferably about 1.78 g/cm³, the melting point is above about 130° C., preferably above about 145° C. and, particularly, preferably about 154-about 155° C., and the enthalpy of fusion is about 40-about 55 J/g, preferably about 44-about 46 J/g.

The viscosity of the initial paste is between about 0.1 and about 15 Pascal, preferably about 1-about 10 Pascal and especially about 3-about 6 Pascal.

### EXAMPLE 1

To prepare the anode, 250 ml of acetone together with 27.8 g of PVDF-HFP (Powerflex, Elf Atochem) were introduced as an initial charge in a 500 ml Erlenmeyer flask and heated to 42° C. in a water bath. The mixture was stirred with a mixer from IKA until the polymer completely dissolved. 6.2 g of conductive black (Super P, Sedema) and 275.3 g of nodular graphite (MCMB 25-28, Osaka Gas) were then added, the mixture stirred for 2 h, the stirring speed being set to a level just below that at which air was stirred in.

The same scheme was followed for the cathode, 250 ml of acetone here being used with 24.8 g of PVDF-HFP (Powerflex, Elf Atochem), 2.6 g of conductive black (Super P, Sedema), 2.6 g of graphite (KS 6, Timcal) as a conductivity improver and 276.2 g of lithium cobalt oxide (FMC).

An anode and cathode were fabricated by means of tape casting with an aerial density of 19-21 g/cm². Mylar (polyester) served as a support foil. The anode was then laminated onto a copper foil at a temperature of 160° C. and with a bearing weight of 45 kg, the effective width in roll lamination being 6 cm. For the cathode, the parameters were 165° C. and 35 kg. From the strips thus laminated, anodes and cathodes having active areas of about 6×3 cm² were punched and laminated to form bicells (cathode/separator/anode/separator/cathode).

The separator was three-layered (PP/PE/PP) and provided with a thin PVDF-HFP layer. First, the separator was laminated to both sides of the anode at 130° C. and 10 kg, and then the top and bottom cathode were laminated there onto in a second lamination step using the same parameters, the effective width here being 3 cm.

### EXAMPLE 2

The same procedure was followed as in Example 1, except that the anode was cast directly onto the copper foil.

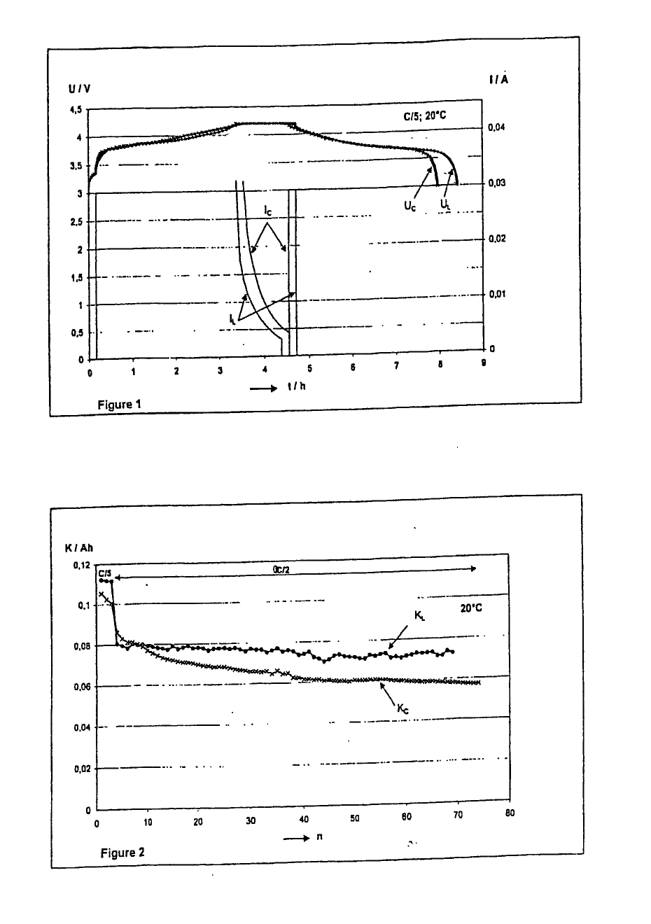

FIG. 1 is a graph showing the trend of discharge voltage and electrode current in a cell according to the invention under a C/5 load. Here, I_{L} and U_{L} denote the current and voltage for electrodes fabricated by lamination (Example 1); I_{C} and U_{C} indicate current and voltage for electrodes fabricated by die casting (Example 2).

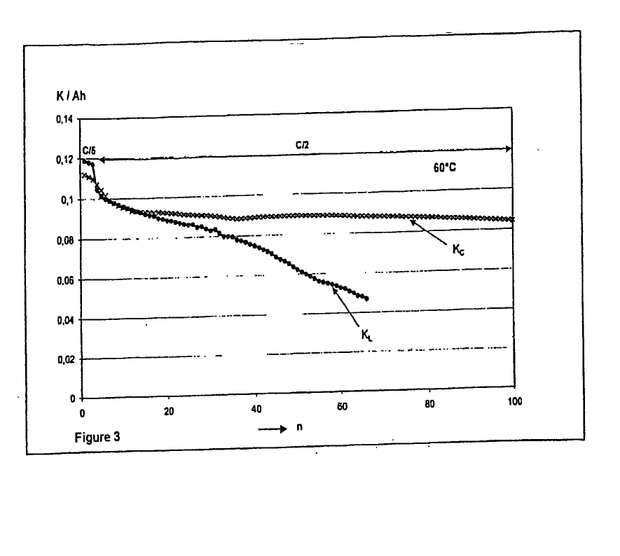

FIGS. 2 and 3 are graphs showing the change of the capacity K as a function of the number of cycles n at temperatures of 20° C. (FIG. 2) and 60° C. (FIG. 3) and currents of C/2. With some initial cycles, the load current was C/5.

K_{L} designates the measured values for laminated electrodes (Example 1) and K_{C} designates measured values for electrodes cast directly onto the collector.

Thus, the invention as described below in the appended claims includes a wet-chemical method of fabricating electrode foils for galvanic elements including dissolving at least two different fluorinated polymers in a solvent, mixing a highly conductive carbon black, whose BET surface area is between that of surface-minimized graphite typically having a BET surface area of 1-11 m²/g and activated carbon typically having a BET of 720-820 m²/g and an electrochemically active material having a two-dimensional layer structure and an electronic conductivity of at lest about 10⁻⁴ S/cm into which lithium can be reversibly incorporated and be reversibly removed therefrom with a co-polymer of at least two polymers dissolved in the solvent, without additions of plasticizers, swelling agents or electrolyte, applying a paste composition thus obtained to an electrode collector or a support foil, and drying the paste composition.

What is claimed is:

1. A wet-chemical method of fabricating electrode foils for galvanic elements comprising:
dissolving a co-polymer of at least two different fluorinated polymers in a solvent;
mixing 1) a highly conductive carbon black, whose BET surface area is between that of surface-minimized graphite and activated carbon and 2) an electrochemically active material having a two-dimensional layer structure and an electronic conductivity of at least about 10⁻⁴ S/cm into which lithium can be reversibly incorporated and be reversibly removed therefrom, with the at least two polymers dissolved in the solvent, without additions of plasticizers, swelling agents or electrolyte to form a paste composition;
applying the paste composition to an electrode collector or a support foil; and
drying the paste composition.

2. The method as claimed in claim 1, wherein the co-polymers are selected from the group consisting of vinylidene fluoride and hexafluoropropylene.

3. The method as claimed in claim 1, wherein the solvents are selected from the group consisting of 1-methyl-2-pyrrolidine and acetone.

4. The method as claimed in claim 1, wherein the electrochemically active material is applied to a positive electrode foil and is a material selected from the group consisting of ternary (Li—Me1-O) and quaternary (Li—Me1-Me2-O) lithium transition metal oxides, wherein Me1 and Me2 are selected from the group consisting of Ti, V, Cr, Fe, Mn, Ni, Co.

5. The method as claimed in claim 4, wherein the material further comprises up to about 15 atom percent of Mg, Al, N or F to stabilize the structure.

6. The method as claimed in claim 1, wherein the electrochemically active material is applied to a negative electrode foil and is a graphitized carbon modification.

7. The method as claimed in claim 1, wherein the active material is applied to a positive electrode foil and is a material having a BET surface area of about 0.1-about 2 m²/g and a particle size of from about 1 to about 50 μm.

8. The method as claimed in claim 1, wherein the active material is applied to positive electrode and is LiCoO₂ with a ratio Li/Co of from about 0.98 to about 1.05.

9. The method as claimed in claim 1, wherein the BET surface area of the carbon black is between about 30 and about 150 m²/g, and the liquid uptake of the carbon black is between about 1-about 20 ml/g.

10. The method as claimed in claim 1, wherein the BET surface area of the carbon black is preferably between about 50 and about 80 m²/g, and the liquid uptake of the carbon black is preferably between about 5-about 10 ml/g.

11. The method as claimed in claim 1, wherein the paste composition is applied to a negative electrode foil and comprises between about 55 and about 95 wt % of carbon material.

12. The method as claimed in claim 1, wherein the paste composition is applied to a negative electrode foil and comprises preferably from about 65 to about 85 wt % of carbon material.

13. The method as claimed in claim 1, wherein the paste composition is applied to a positive electrode foil and comprises between about 65 and about 98 wt % of a lithium transition metal oxide.

14. The method as claimed in claim 1, wherein the paste composition is applied to a positive electrode foil and comprises preferably from about 75 to about 95 wt % of a lithium transition metal oxide.

15. The method as claimed in claim 1, wherein the paste composition comprises from about 50 to about 75 wt % of solvent.

16. The method as claimed in claim 1, wherein the paste composition is applied to form a positive electrode foil and the PVDF/HFP ratio is between at most about 99.5 and at least about 0.5, and wherein the ratio of the molecular weights between PVDF/HFP is between about 3.2 and about 2.8.

17. The method as claimed in claim 1, wherein the paste composition is applied to form a negative electrode foil and the PVDF/HFP ratio is between at most about 99.5 and at least about 0.5, and wherein the ratio of the molecular weights between PVDF/HFP is between about 3.2 and about 2.8.

18. The method as claimed in claim 1, wherein the viscosity of the paste composition is initially adjusted to from about 1 to about 10 Pascal.

19. A galvanic element comprising at least one electrode foil which is fabricated via a method as claimed in claim 1.

20. The galvanic element as claimed in claim 19, wherein a positive electrode foil and a negative electrode foil fabricated via said method are laminated onto a separator and a thus obtained stack is impregnated with a liquid organic electrolyte.
